(19) United States
(12) Patent Application Publication
(10) Pub. No.: US 2016/0290602 A1
(43) Pub. Date: Oct. 6, 2016

(54) HOUSING OF ELECTRONIC DEVICE

(71) Applicant: HON HAI PRECISION INDUSTRY CO., LTD., New Taipei (CN)

(72) Inventor: SHAO-HAN CHANG, New Taipei (TW)

(21) Appl. No.: 14/726,038

(22) Filed: May 29, 2015

(30) Foreign Application Priority Data
Mar. 30, 2015 (CN) 201510142570.9

(51) Int. Cl. F21V 11/14; F21V 8/00

(52) U.S. Cl. CPC F21V 11/14; G02B 6/0043; G02B 6/0016; G02B 6/009; G02B 6/002

(57) ABSTRACT

A housing of an electronic device includes a base plate, a frame, a light guide film and a light source. An inner surface of the base plate includes a coating. A plurality of light transmission holes are defined in the coating. The frame includes a first receiving portion and a second receiving portion surrounded by the first receiving portion. The base plate is received in the first receiving portion and the light guide film is received in the second receiving portion. The light source is coupled to the light guide film. One end of the light guide film covers the plurality of light transmission holes, and an other end of the light guide film is optically coupled to the light source. Light from the light source transmits through the light guide film and emits out of the base plate by the light transmission holes.

### FIELD

The subject matter herein generally relates to housings of electronic devices, especially to a housing of an electronic device with a formed light-emitting portion.

### BACKGROUND

A housing of an electronic device defines a plurality of light transmission holes, arranged in a predetermined shape. Light from a light source in the electronic device emits out of the housing through the light transmission holes, and a light-emitting portion is formed from the housing.

### BRIEF DESCRIPTION OF THE DRAWINGS

Implementations of the present technology will now be described, by way of example only, with reference to the attached figures.

FIG. 1 is a diagrammatic view of an embodiment of a housing of an electronic device.

FIG. 2 is an exploded isometric view of the housing of the electronic device of FIG. 1.

FIG. 3 is a cross-sectional view of the housing of the electronic device across line III-III of FIG. 1.

FIG. 4 is a partially enlarged view of the housing of circle IV in FIG. 3.

FIG. 5 is a distribution view of light emission angles of the housing of the electronic device of FIG. 4.

FIG. 6 is a partially enlarged view of second embodiment of a housing of an electronic device.

FIG. 7 is a partially enlarged view of third embodiment of a housing of an electronic device.

FIG. 8 is a diagrammatic view of fourth embodiment of a housing of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

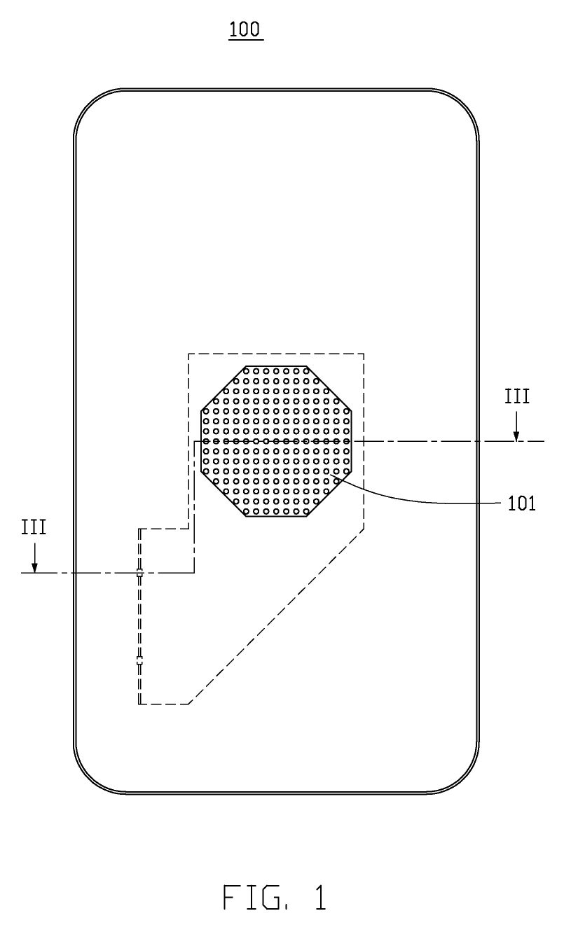

FIG. 1 illustrates an embodiment of a housing 100 of an electronic device (not shown). The housing 100 can include a light-emitting portion 101. Light can emit out of the housing 100 through the light-emitting portion 101 when the electronic device is in a specific state, such as Short Message Service (SMS) alert, to inform the user of an incoming SMS.

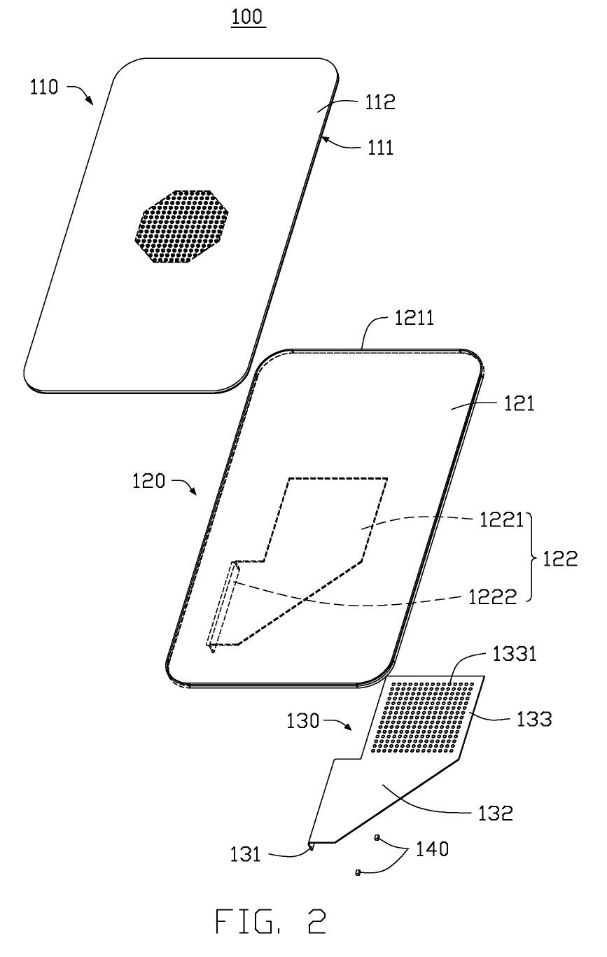

FIG. 2 illustrates that the housing 100 can include a base plate 110, a frame 120, a light guide film 130 and a light source 140.

The base plate 110 can be a substantially flat plate and made of transparent materials, such as glass, sapphire, transparent ceramics. The base plate 110 can include an inside surface 111 and an outside surface 112.

The frame 120 can be made of plastic materials, and include a first receiving portion 121 configured to receive the base plate 110 and a second receiving portion 122 configured to receive the light guide film 130. An edge of the first receiving portion 121 can include a circular lip 1211 attached to an edge of the base plate 110. The lip 1211 can prevent the base plate 110 from being damaged. The second receiving portion 122 can be defined in a predetermined portion of the first receiving portion 121. The first receiving portion 121 can surround the second receiving portion 122. The second receiving portion 122 can define a hollow portion 1221 and include a support portion 1222 arranged at an edge of the hollow portion 1221. The hollow portion 1221 can be defined in a predetermined portion of the first receiving portion 121. A shape of the hollow portion 1221 can be substantially same as a shape of the light guide film 130, and can be configured to receive the light guide film 130. The support portion 1222 can be configured to support the light guide film 130.

The light guide film 130 can include a light input portion 131, a light guide portion 132 and a light output portion 133. The light input portion 131 can be coupled with the light guide portion 132 at a predetermined angle. The light input portion 131 can be close to the light source 140 to improve the light-transmitting efficiency of the light guide film 130. The light guide portion 132 can be coupled with the light output portion 133, and be configured for transmitting light from the light input portion 131 to the light output portion 133. The light output portion 133 can include a scattering microstructure 1331, and light can emit out of the light guide film 130 through the scattering microstructure 1331.

The light source 140 can be closely coupled to the light guide film 130 and configured to emit light for the housing 100. In the illustrate embodiment, the light source 140 can include a plurality of light-emitting diodes (LEDs). The plurality of LEDs can emit different color light.

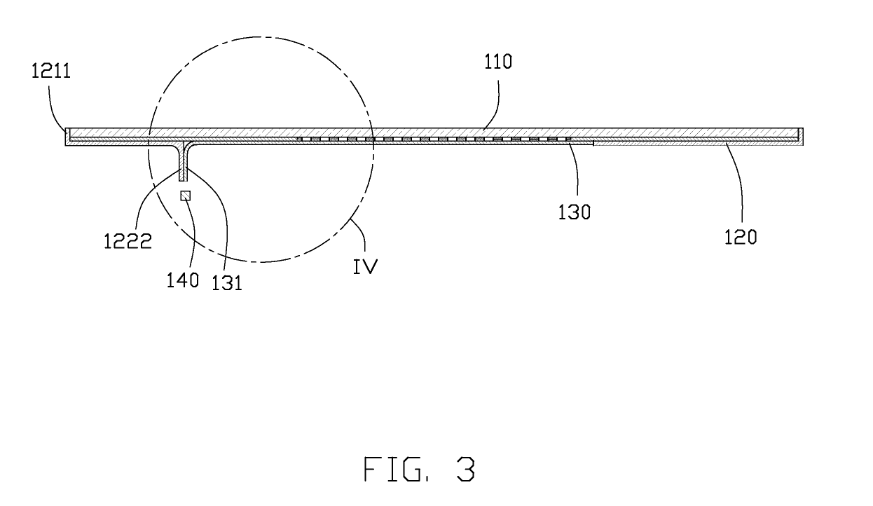

FIG. 3 illustrates that the base plate 110 can be received in the frame 120, and the lip 1211 can be attached with the edge of the base plate 110 to prevent the base plate 110 from being damaged. The light guide film 130 can be received in the frame 120, and the light input portion 131 can be attached with the support portion 1222. The support portion 1222 can support the light input portion 131. The light source 140 can be closely coupled to the light input portion 131.

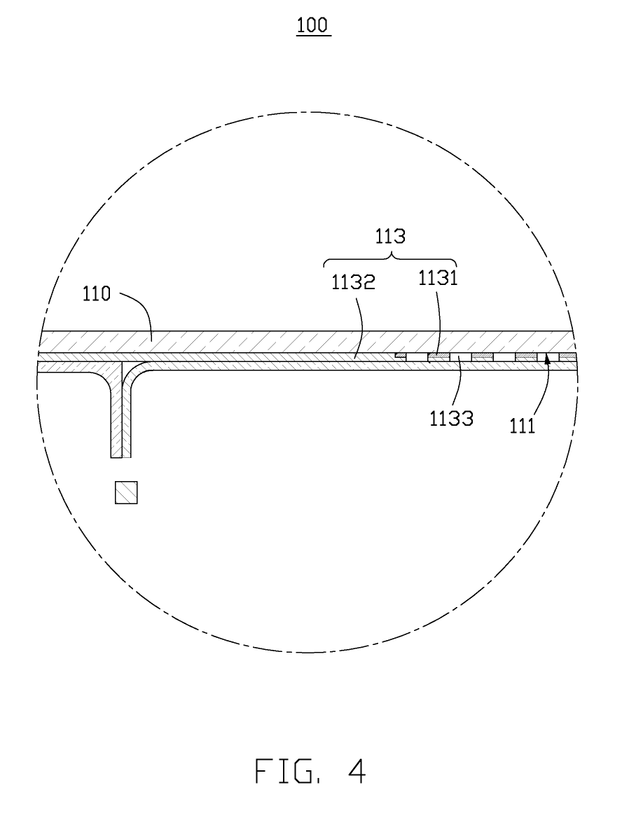

FIG. 4 illustrates that the base plate 110 can further include a coating 113 attached to the inside surface 111 of the base plate 110. The coating 113 can include a trademark layer 1131 and a shade layer 1132. The trademark layer 1131 can be coated on partial areas of the inside surface 111 to form a predetermined word or graphic, such as a trademark or logo. The shade layer 1132 can be coated on the total areas of the inside surface 111 to cover the trademark layer 1131 and the inside surface 111. The shade layer 1132 can be configured to isolate the transmission of light from the base plate 110, and can be different colors to give the housing 100 a predetermined background color. A plurality of light transmission holes 1133 can be defined in the overlapping areas of the trademark layer 1131 and the shade layer 1132 to form the light-emitting portion 101 (as shown in FIG. 1). A diameter of each light transmission hole 1133 can be 50 μm or less.

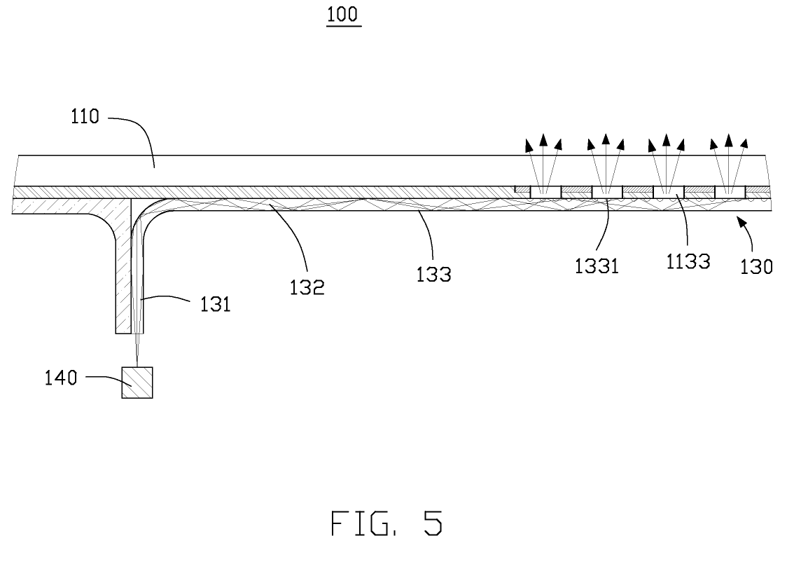

FIG. 5 illustrates that one end of the light guide film 130 can be optically coupled to the light source 140, and light from the light source 140 can enter the light guide film 130. An other end of the light guide film 130 can cover the plurality of light transmission holes 1133. Light from the light source 140 can enter the light guide portion 132 through the light input portion 131 and light from the light guide portion 132 can transmit to the light output portion 133 through reflection and total reflection. The scattering microstructure 1331 can cover the plurality of the light transmission holes 1133. The light can be scattered by the scattering microstructure 1331 and can pass through the light transmission holes 1133 to the outside of the housing 100. In another embodiment, a surface of the light guide film 130 away from the base plate 110 can include a reflective film (not shown).

In another embodiment, the frame 120 can further include a plurality of latches to allow coupling with other components of the housing 100.

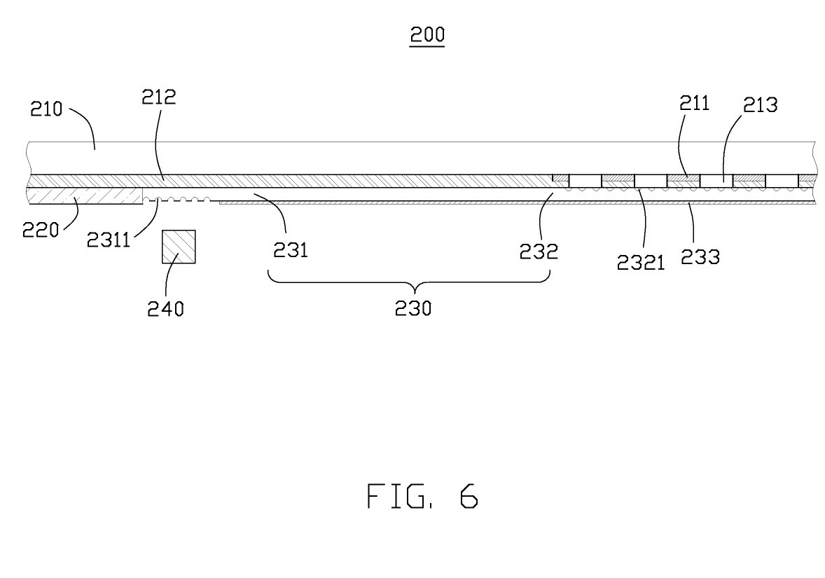

FIG. 6 illustrates the second embodiment of a housing 200 of an electronic device (not shown). The housing 200 can include a transparent base plate 210, a frame 220, a light guide film 230 and a light source 240. A trademark layer 211 can be coated on partial areas of an inside surface of the base plate 210. A shade layer 212 can be coated on the total areas of the inside surface of the base plate 210 to cover the trademark layer 211 and the inside surface of the base plate 210. Overlapping areas of the trademark layer 211 and the shade layer 212 can define a plurality of light transmission holes 213. The frame 220 can be configured to receive the base plate 210 and the light guide film 230. The light guide film 230 can be configured for transmitting light from the light source 240 to the light transmission holes 213.

The light guide film 230 can include a light guide portion 231 and a light output portion 232 coupled with the light guide portion 231. The light guide portion 231 and the light output portion 232 can be on the same level. The light source 240 can be closely coupled to the light guide film 230. A surface of the light guide film 230 away from the base plate 210 can include a reflective film 233. A portion of the light output portion 232 near the light transmission holes 213 can define a first scattering microstructure 2321, and the first scattering microstructure 2321 can be attached to the plurality of the light transmission holes 213. Light from the light guide film 230 can be transmitted to the light transmission holes 213 through the first scattering microstructure 2321, and can pass through the base plate 210 to the outside of the housing 200. A portion of the light guide portion 231 near the light source 240 can define a second scattering microstructure 2311. The second scattering microstructure 2311 can be optically coupled to the light source 240, and light from the light source 240 can enter the light guide film 230 through the second scattering microstructure 2311.

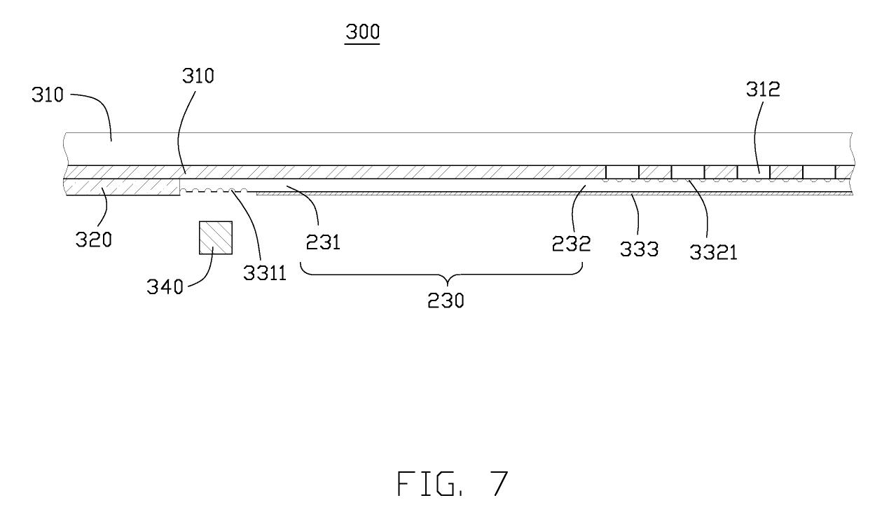

FIG. 7 illustrates the third embodiment of a housing 300 of an electronic device (not shown). The housing 300 can include a transparent base plate 310, a frame 320, a light guide film 330 and a light source 340. The frame 320 can be configured to receive the base plate 310 and the light guide film 330. The light guide film 330 can include a light guide portion 331 and a light output portion 332 coupled with the light guide portion 331. The light guide portion 331 and the light output portion 332 can be on a same level. The light source 340 can be closely coupled to the light guide portion 331. A surface of the light guide film 330 away from the base plate 310 can include a reflective film 333. The light output portion 332 can define a first scattering microstructure 3321, and a portion of the light guide portion 331 near the light source 340 can define a second scattering microstructure 3311.

A shade layer 311 can be coated on the total areas of the inside surface of the base plate 310. A plurality of light transmission holes 312 arranged in a predetermined shape can be defined on a predetermined portion of the shade layer 311.

The second scattering microstructure 3311 can be optically coupled to the light source 340, and light from the light source 340 can enter the light guide film 330 through the second scattering microstructure 3311. The first scattering microstructure 3321 can be attached to the plurality of the light transmission holes 312. Light from the light guide film 330 can be transmitted to the light transmission holes 312 through the first scattering microstructure 3321, and can pass through the base plate 310 to the outside of the housing 300.

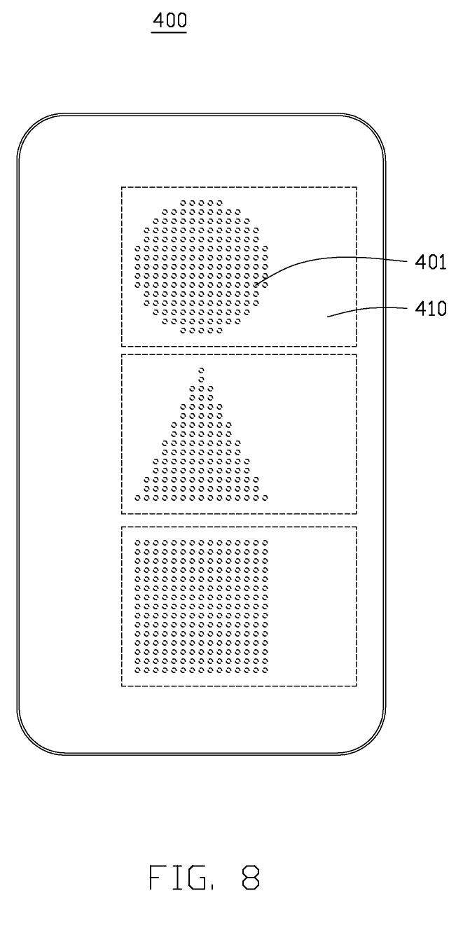

FIG. 8 illustrates the fourth embodiment of a housing 400 of an electronic device (not shown). The housing 400 can include a plurality of light-emitting portions 401, and shapes of the light-emitting portions 401 can be set depending on need. A plurality of light guide film 410 can be attached to the light-emitting portions 401, and light in the plurality of light-emitting portions 401 can be isolated from each other. When the electronic device is in different states, such as Short Message Service (SMS) alert and Caller Identification (CID), the light-emitting portions 401 can emit light to inform the user of an incoming SMS or CID.

The embodiments shown and described above are only examples. Many details are often found in the art such as the other features of housing of electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A housing of an electronic device comprising:
a base plate comprising
a coating attached to an inside surface of the base plate and defining a plurality of light transmission holes;
a frame comprising
a first receiving portion configured to receive the base plate; and
a second receiving portion surrounded by the first receiving portion;
a light guide film received in the second receiving portion; and
a light source coupled to the light guide film;
wherein one end of the light guide film covers the plurality of light transmission holes, and an other end of the light guide film is optically coupled to the light source, whereby
light from the light source transmits through the light guide film and emits out of the base plate by the light transmission holes.

2. The housing as claimed in claim 1, wherein the coating comprises a shade layer coated on total areas of the inside surface of the base plate.

3. The housing as claimed in claim 2, wherein the plurality of light transmission holes are defined in the shade layer.

4. The housing as claimed in claim 2, wherein the coating further comprises a trademark layer, and the trademark layer is coated on partial areas of the inside surface to form a predetermined shape.

5. The housing as claimed in claim 4, wherein the shade layer covers the trademark layer, and the plurality of light transmission holes are defined in the overlapping areas of the trademark layer and the shade layer.

6. The housing as claimed in claim 1, wherein
the light guide film comprises a light guide portion and a light output portion coupled with the light guide portion;
the light output portion defines a first scattering microstructure; and
the first scattering microstructure is attached to the plurality of the light transmission holes.

7. The housing as claimed in claim 6, wherein the light guide portion defines a second scattering microstructure, and the second scattering microstructure is optically coupled to the light source.

8. The housing as claimed in claim 6, wherein the light guide film further comprises a light input portion, and the light input portion is coupled with the light guide portion at a predetermined angle.

9. The housing as claimed in claim 1, wherein an edge of the first receiving portion comprises a circular lip attached to an edge of the base plate.

10. The housing as claimed in claim 1, wherein
the second receiving portion comprises a hollow portion and a support portion arranged to an edge of the hollow portion;
the hollow portion is configured to receive the light guide film; and
the support portion is configured to support the light guide film.

11. The housing as claimed in claim 1, wherein the housing comprises a plurality of light-emitting portions, and light in the plurality of light-emitting portions is isolated from each other.
